(19) United States
(12) Patent Application Publication
(10) Pub. No.: US 2008/0017729 A1
(43) Pub. Date: Jan. 24, 2008

(54) High volume dripping hoses

(76) Inventor: Kuang-Bao Ou-Young, Sunnyvale, CA (US)

Correspondence Address: Kuang-Bao Ou-Young, 1362 Wright Ave., Sunnyvale, CA, 94087, US

(21) Appl. No.: 11/482,703

(22) Filed: Jul. 7, 2006

(51) Int. Cl. A01G 27/00

(52) U.S. Cl. 239/145; 239/542

(57) ABSTRACT

A dripping hose having a center hose (12) and one or more segments of corrugated outer hose (10), with each segment of corrugated outer hose (10) enclosing a metering section of center hose (12). Each metering section of center hose (12) has a number of longitudinally and evenly spaced metering holes (18), or comprises a segment of porous soaker hose (28). The outer hose (10) has drain holes (16) on the underside crests of its corrugations. The dripping hose distributes high volume dripping streams uniformly along its length.

### CROSS-REFERENCE TO RELATED APPLICATIONS

Not Applicable

### FEDERALLY SPONSORED RESEARCH

Not Applicable

### SEQUENCE LISTING OR PROGRAM

Not Applicable

### BACKGROUND OF THE INVENTION

1. Field of Invention

This invention relates to dripping hoses, specifically to high volume dripping hoses.

2. Prior Art

Spraying and drip irrigation are common methods of irrigation. Sprinklers and sprinkler hoses are devices for spraying irrigation water to plants. Drippers and drip irrigation hoses are the main functional components of drip irrigation systems. Soaker hoses deliver a seeping flow of water to plants.

U.S. Pat. No. 6,991,181 to Alexander et al. (2006) discloses a coil shaped sprinkler hose. U.S. Pat. No. 4,454,989 to Alston (1984) discloses sprinkling hoses with triangular coil shapes.

Sprinkler hoses supply high volumes of water. The high flow rates of irrigation water cause considerable waste in runoff. Furthermore, spray irrigation water does not distribute uniformly at the root zones of plants. For these reasons farmers and gardeners often prefer drip irrigation.

A number of patents on drip emitters or emitter based drip irrigation lines have issued. U.S. Pat. No. 6,736,337 to Vildibill et al. (2004), U.S. Pat. No. 6,581,854 to Eckstein et al. (2003), and U.S. Pat. No. 6,206,305 to Mehoudar (2001) are examples of such patents.

Drip emitters have complex flow paths to produce the desired dripping flow. Thus drip emitters are subject to clogging. They also require special equipment to make. Variations in manufacturing cause the actual flow rates to vary for emitters of the same capacity. Further, drip emitters cannot be placed close together in a drip irrigation line, due to their physical sizes and limitations in the manufacturing process. The volumes of water delivered by emitter based irrigation lines per unit length are thus very low. The ensuing long watering time promotes fungus growth. Since most plants do better with less frequent watering and more water per application, low volume irrigation is far from optimum for plants.

U.S. Pat. No. 4,756,339 to Buluschek (1988), U.S. Pat. No. 4,053,109 to Gilead (1977), and U.S. Pat. No. 4,022,384 to Hoyle et al. (1977) disclose irrigation hoses having an inner hose within an outer hose. Flow paths formed between the inner hose and the outer hose produce the desired dripping flow.

These irrigation hoses suffer the same drawbacks as those of drip emitters and emitter based irrigation lines. The drawbacks include difficulties in manufacturing and low delivered volume of water, as well as prone to clogging.

U.S. Pat. No. 5,913,635 to Graham (1999), U.S. Pat. No. 5,129,758 to Lindström (1992), and U.S. Pat. No. 4,904,112 to McDonald (1990) disclose pipes having an inner pipe within an outer pipe. Water flows through the openings on the inner pipe to the inside of the outer pipe. From there the water flows through openings on the outer pipe to ground soil. However, these pipes do not have provisions for uniform distribution of irrigation water.

U.S. Pat. No. 5,368,235 to Drozdoff et al. (1994) discloses soaker hose assemblies with embedded flow restrictors. Similar soaker hoses without the flow restrictors are available from Aquapore Moisture Systems, Inc. of Phoenix, Ariz. and other companies. These soaker hoses have very low (seeping) flow rates and operate at pressures above 480 kPa (70 psi). A high operating pressure requires a thicker wall for these soaker hoses, making them more rigid. A high operating pressure also requires more expensive fittings to connect these hoses.

A ¼ inch porous soaker hose is available from Raindrip, Inc. of Fresno, Calif. and other companies. The porous soaker hose operates under 240 kPa (35 psi) and provides higher flow rates due to its higher porosity. As porosity can be difficult to control, the porous soaker hose does not guarantee uniform distribution of water along its length.

All the irrigation lines described have smooth outer surfaces. Water drips emitted from such lines tend to adhere to the lines and often drip to ground some distances away from the drip openings. This results in non-uniform distribution of water along the irrigation lines. The situation gets much worse when the ground is uneven or on a slope.

3. Objects and Advantages

In view of the disadvantages described in prior art, the objects and advantages of the present invention include:

(a) ease of manufacturing

(b) high volume of delivered water per unit length

(c) uniform distribution of water even on uneven ground

(d) resistance to clogging (e) ease of use or installation.

### SUMMARY

In accordance with the present invention a dripping hose comprises a center hose and one or more segments of corrugated outer hose, with each segment of the corrugated outer hose enclosing a metering section of the center hose. Each metering section of the center hose has a number of longitudinally and evenly spaced metering holes or comprises a segment of porous soaker hose. The corrugated outer hose has drain holes on the underside crests of its corrugations. The center hose sprays metered water in the outer hose. The outer hose reduces the velocities of the water sprays, keeps the water streams separate, and drains the water in drips to ground uniformly along its length.

### DRAWINGS—FIGURES

FIG. 1 shows a short dripping hose.

FIG. 2 shows a sectional perspective view of the same hose.

FIG. 3 shows the center hose of the short dripping hose.

FIG. 4 shows (the front view of) a long dripping hose.

FIG. 5 shows a dripping hose with more than two dripping (metering) sections.

FIG. 6 shows a long dripping hose installed with an upstream pressure regulator.

FIG. 7 shows the center hose of an alternative dripping hose.

FIG. 8 shows a sectional perspective view of the alternative dripping hose.

### DRAWINGS—REFERENCE NUMERALS

10 outer hose
12 center hose
14L left spacer
14R right spacer
16 drain hole
18 metering hole
20 main supply line
22 pressure regulator
24 branch line
26 connector
28 porous soaker hose
30 non-porous hose

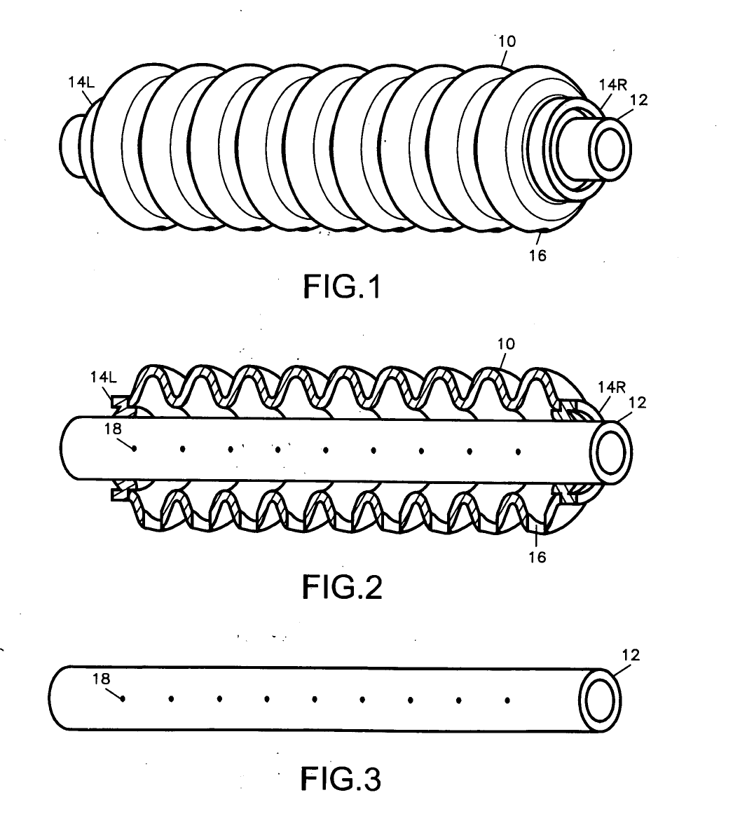

### DETAILED DESCRIPTION—FIGS. 1-5—PREFERRED EMBODIMENT

A preferred embodiment of the dripping hose of the present invention is illustrated in FIGS. 1 through 5. The dripping hose has a center hose 12 with one or more metering sections. Each metering section of center hose 12 has a number of longitudinally and evenly spaced metering holes 18. A segment of corrugated outer hose 10 encloses a corresponding metering section of center hose 12. Corrugated outer hose 10 has drain holes 16 on the underside crests of its corrugations. Left and right spacers 14L 14R lock a segment of outer hose 10 in a fixed longitudinal position with respect to center hose 12.

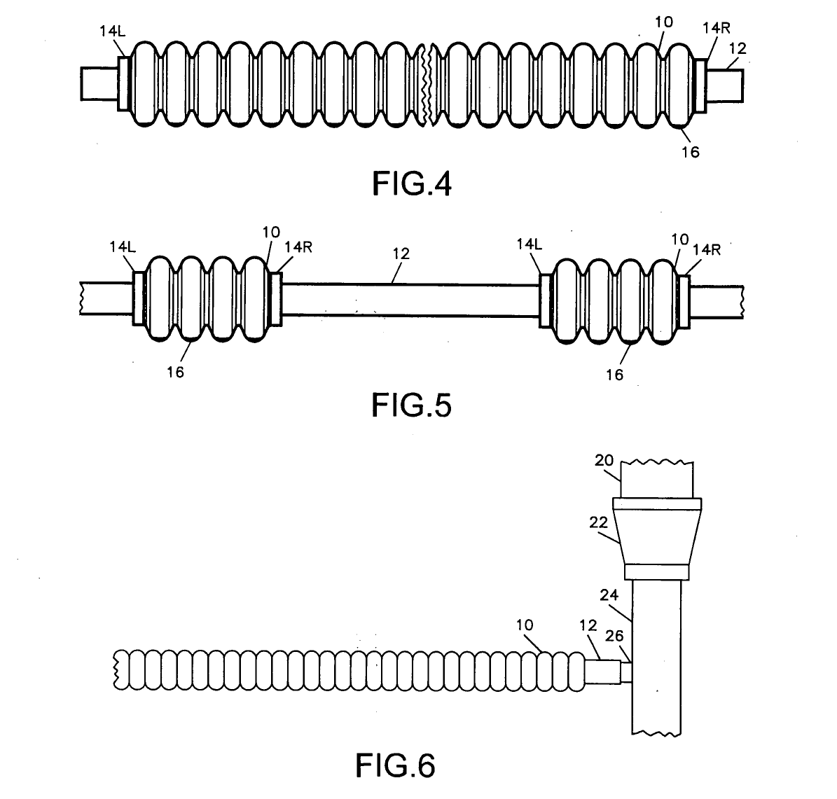

A metering section of center hose 12, its enclosing segment of outer hose 10, as well as left and right spacers 14L 14R form a dripping section of the dripping hose. A dripping hose can have a long continuous dripping section (FIG. 4). This type of dripping hoses is suited for hedges or where plants are spaced close together in rows. A dripping hose may have many relatively short and separate dripping sections (FIG. 5). This type of dripping hoses is suitable for where plants are spaced further apart.

The orientation of metering holes 18 sets the direction water sprays from hole 18. The preferred orientation of metering holes 18 is between 3 o'clock and 9 o'clock clockwise as viewed from either end of a dripping hose. The downward orientations (around 6 o'clock) are avoided to prevent water from spraying directly through holes 16.

Preferably, there is just one metering hole 18 at a longitudinal location on center hose 12. The distance between adjacent metering holes 18 (pitch) is preferably the same as the distance between adjacent corrugations (pitch) of outer hose 10. Hence there is one metering hole 18 per corrugation of outer hose 10. The preferred pitch of metering holes 18 and corrugations of outer hose 10 is 25 mm (11n) or less. Closer spacing of metering holes 18 provides higher volumes of dripping water.

### OPERATIONS—FIGS. 2, 6

Irrigation water flows from main supply line 20 to pressure regulator 22. The irrigation water exits pressure regulator 22 and flows in branch line 24. From branch line 24 the water flows through connector 26 to center hose 12. From center hose 12 the water sprays through metering holes 18 and in outer hose 10. Water in outer hose 10 looses most of its velocity and drains through drain holes 16 in drips to ground.

Main supply line 20 may run a long distance. Hence the resultant pressure drop along line 20 can be significant. Pressure regulator 22 maintains a constant pressure in branch line 24, eliminating the effect of uneven pressure drop along main supply line 20. The preferred outlet pressure of pressure regulator 22 is 240 kPa (35 psi) or less.

Low outlet pressure of pressure regulator 22 allows the use of less expensive fittings with the dripping hoses. Low operating pressure in center hose 12 allows thin wall thickness for center hose 12. Thin wall thickness keeps the cost of center hose 12 down while increasing its flexibility.

A flow rate between 1.9 and 7.6 liters per hour (0.5 and 2 gallons per hour) through metering holes 18 is suitable for most soils. The main function of metering holes 18 is to maintain a constant flow rate among themselves. The diameter of a metering hole 18 and the pressure drop across it determine the flow rate.

For a given flow rate, lower operating pressure in center hose 12 means bigger metering holes 18. Bigger metering holes 18 improve the clogging resistance of a dripping hose. Because for the most part of center hose 12 the water flow has a major component flowing downstream while a small flow component of the water was spraying through metering hole 18, the dripping hose has an inherent tendency to resist clogging.

Limiting the number and the lengths of dripping hoses fed by branch line 24 keeps the pressure drop along line 24 small. The pressure drop from branch line 24 to close by metering hole 18 is very small. The pressure drop from branch line 24 to metering hole 18 downstream a long center hose 12 can be significant. Three methods to compensate for large pressure drop in dripping hoses are described. These three methods can be used independently or in combination.

The first method of compensation is to make metering holes 18 downstream a long center hose 12 successively bigger. The second method is to suspend the dripping hose in a slope with the downstream end lower than the upstream end for a proper amount. The gravity pull of water automatically compensates for the pressure drop. The third method is to manufacture successively more metering holes 18 per unit length downstream a long center hose 12.

The corrugations of outer hose 10 keep the water sprays emitting from metering holes 18 separate in outer hose 10. The water sprays loose most of their velocities in outer hose 10. Because drain holes 16 are on the underside crests of the corrugations of outer hose 10, water drips from adjacent drain holes 16 remain separate as they exit outer hose 10. This has the effect of uniform distribution of irrigation water along a dripping hose even if the ground is uneven or on a slope.

The left and right spacers 14L 14R work the same way as plastic compression fittings do. The bore of the ends of spacers 14L 14R facing outer hose 10 is slightly larger than the outside diameter of center hose 12 and has a round edge. The bore of the other ends of spacers 14L 14R is slightly smaller than the outside diameter of center hose 12 and has a sharp edge. Spacers 14L 14R push easily toward outer hose 10 but do not in opposite directions. As spacers 14L 14R push to match with outer hose 10, outer hose 10 is locked in fixed longitudinal position with respect to center hose 12. A pair of hose clamps can replace spacers 14L 14R to lock outer hose 10 in fixed longitudinal position with respect to center hose 12.

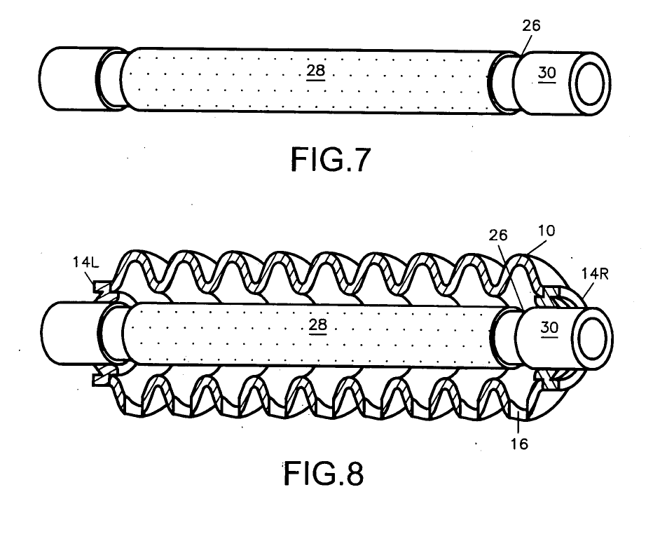

### FIGS. 7-8—ALTERNATIVE EMBODIMENT

FIG. 7 shows an alternative center hose for a dripping hose. With this center hose a segment of porous soaker hose 28 meters water for delivery. The segment of porous soaker hose 28 connects with non-porous hoses 30 through connectors 26. Porosity of hose 28 and its operating pressure determine the flow rate of this dripping hose. FIG. 8 shows a dripping hose with the alternative center hose.

### ADVANTAGES

From the description above, a number of advantages of my high volume dripping hoses become evident:

(a) The high volume dripping hoses are easy to manufacture, due to their simple structure.

(b) The high volume dripping hoses are easy to install and customize, due to their low operating pressures.

(c) High volume dripping hoses provide optimum irrigation for plants.

(d) Distribution of water is uniform along the dripping hoses even if the ground is uneven or on a slope.

(e) The high volume dripping hoses are inherently clogging resistant. Hence these hoses can provide many years of trouble-free service.

### CONCLUSION, RAMIFICATIONS, AND SCOPE

Accordingly, the reader will see that the high volume dripping hoses of this invention are easy to manufacture, are easy to install and customize, provide optimal irrigation for plants, distribute water uniformly, and are inherently clogging resistant.

Although the description above contains many specificities, these should not be construed as limiting the scope of the invention but as merely providing illustrations of some of the presently preferred embodiments of this invention. For example, a rigid pipe or tube with suitable metering sections can replace the center hose of a dripping hose of this invention to provide structural rigidity in certain applications.

Thus the scope of the invention should be determined by the appended claims and their legal equivalents, rather than by the examples given.

I claim:

1. A high volume dripping hose comprising:
(a) a center hose having one or more metering sections and
(b) equal number of segments of corrugated outer hose enclosing said metering sections of said center hose respectively, with
(c) each of said metering section of said center hose having a plurality of longitudinally and evenly spaced metering holes and
(d) each of said segment of said corrugated outer hose having drain holes on the underside crests of the corrugations.

2. The dripping hose of claim 1 wherein means for locking said segment of said outer hose in fixed longitudinal position with respect to said metering section of said center hose is provided to increase structural integrity of said dripping hose.

3. A high volume dripping hose comprising:
(a) a center hose having one or more metering sections and
(b) equal number of segments of corrugated outer hose enclosing said metering sections of said center hose respectively, with
(c) each of said metering section of said center hose comprising a segment of porous soaker hose and
(d) each of said segment of said corrugated outer hose having drain holes on the underside crests of the corrugations.

4. The dripping hose of claim 3 wherein means for locking said segment of said outer hose in fixed longitudinal position with respect to said metering section of said center hose is provided to increase structural integrity of said dripping hose.

5. A method for producing high volume dripping streams, comprising:
(a) spraying liquid uniformly along a liquid conducting line at a predetermined flow rate for each spray,
(b) receiving each of said sprays in an individual chamber,
(c) reducing the velocities of said sprays in said chambers,
(d) draining the liquid in said chambers through drain holes to produce dripping streams,
(e) providing a means to keep said dripping streams exiting from said drain holes separate,
whereby said dripping streams distribute uniformly along said liquid conducting line.
